(19) United States
(12) Patent Application Publication
(10) Pub. No.: US 2026/0095270 A1
(43) Pub. Date: Apr. 2, 2026

(54) SYSTEMS AND METHODS FOR TIMER SYNCHRONIZATION

(71) Applicant: Advanced Micro Devices, Inc., Santa Clara, CA (US)

(72) Inventors: Lu Lu, Beijing (CN); Richard Martin Born, Fort Collins, CO (US); Noah B. Beck, Boxborough, MA (US); Biao Zhou, Shanghai (CN); Phong T. Phan, Austin, TX (US)

(73) Assignee: Advanced Micro Devices, Inc., Santa Clara, CA (US)

(21) Appl. No.: 18/899,463

(22) Filed: Sep. 27, 2024

(51) Int. Cl. H04J 3/06

(52) U.S. Cl. CPC H04J 3/0661

(57) ABSTRACT

A method can include capturing, by a device corresponding to at least one of a socket or a circuit die, an activation edge of a synchronization event. The method can additionally include offsetting, by the device and based on the capture of the activation edge of the synchronization event, a time stamp counter value. Various other methods and systems are also disclosed.

### BACKGROUND

A central processing unit (CPU) can be a primary component of a computer that acts as its “control center.” The CPU, also referred to as the “central” or “main” processor, can be a complex set of electronic circuitry that runs the machine's operating system and applications. A CPU can often be connected to one or more co-processing units, such as one or more graphics processing units (GPUs), one or more accelerator processing units (APUs), etc.

A GPU is an electronic circuit that can perform mathematical calculations at high speed. Computing tasks like graphics rendering, machine learning (ML), and video editing involve the application of similar mathematical operations on a large dataset.

An APU, such as a deep learning processor or neural processing unit, is a class of specialized hardware accelerator or computer system designed to accelerate artificial intelligence and machine learning applications, including artificial neural networks and machine vision. An APU can often combine both a CPU and a GPU onto a single chip.

A System-on-a-Chip (SoC) can be a type of integrated circuit (IC) design that combines many or all high-level function elements of an electronic device onto a single chip instead of using separate components mounted to a printed circuit board (PCB), such as a motherboard. In an SoC, the CPU can be fully integrated with memory, GPUs, and more on a single chip.

Processing units, such as CPUs, GPUs, APUs, and SoCs, can be composed of circuit die, which can be small blocks of semiconducting material on which functional circuits are fabricated. For example, integrated circuits can be produced in large batches on a single wafer of electronic-grade silicon (EGS) or other semiconductor (e.g., GaAs) through processes such as photolithography. A wafer can be cut (e.g., diced) into many pieces, each containing one copy of the circuit. Each of these pieces can be referred to as a die. There are three commonly used plural forms: dice, dies, and die. To simplify handling and integration onto a PCB, most die are packaged in various forms. An SoC can be implemented on a single die (e.g., a monolithic die) or be composed of multiple die that can be arranged and connected in various ways.

A PCB can be a medium used in electrical and electronic engineering to connect electronic components to one another in a controlled manner. For example a PCB can take the form of a laminated sandwich structure of conductive and insulating layers, with each of the conductive layers being designed with an artwork pattern of traces, planes, and other features (e.g., like wires on a flat surface) etched from one or more sheet layers of copper laminated onto and/or between sheet layers of a non-conductive substrate. Electrical components can be fixed to conductive pads on the outer layers in the shape designed to accept the component's terminals, generally by means of soldering, to both electrically connect and mechanically fasten them to it. Another manufacturing process can add vias, such as plated-through holes that allow interconnections between layers. PCBs can be single-sided (e.g., one copper layer), double-sided (e.g., two copper layers on both sides of one substrate layer), or multi-layer (e.g., outer and inner layers of copper, alternating with layers of substrate). Multi-layer PCBs allow for much higher component density because circuit traces on the inner layers would otherwise take up surface space between components. SoCs and/or circuit dies can be mounted in one or more sockets of a PCB, and some sockets can accommodate mounting of multiple SoCs and/or circuit dies.

A socket can be an electrical component of a land grid array (LGA) package or pin grid array (PGA) package that provides compressive electrical interconnect between a PCB and a processor. For example, an LGA socket can offer a more durable CPU as the contact pins are on the motherboard socket. In contrast, a PGA socket can offer a more durable motherboard as the pins are on the processor. However, LGA pins are smaller than PGA pins and hence, the LGA socket can offer more space efficiency.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an example system with timer synchronization.

FIG. 2 is a flow diagram of an example method for timer synchronization.

FIG. 3 is a block diagram of an example system implementing timer synchronization.

FIG. 4 is a graphical illustration of example timer synchronization signaling.

FIG. 5 is a graphical illustration of example timer synchronization signaling.

FIG. 6 is a block diagram of example systems implementing timer synchronization.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to timer synchronization. For example, the disclosed systems and methods can synchronize devices (e.g., circuit dies and/or sockets) by capturing an activation edge of a synchronization event and offsetting a time stamp counter value. Benefits obtained by the disclosed systems and methods can include reduced skew among different time stamp counters of the synchronized devices, such as time skew caused by asynchronous reset release of different time stamp counters among different devices.

In an example, each SoC of a system can include one or more golden time stamp counters that provide one or more reference points for all processor cores (e.g., CPU cores, GPU cores, etc.) within a socket. A socket input output (I/O) pin can be added per socket as a timer synchronization event trigger. Each die (e.g., CPU die, GPU die, etc.) can include an I/O pin connected (e.g., shorted) to a single timer synchronization bus implemented in a socket substrate and/or a PCB design.

The disclosed systems and methods can synchronize time stamp counter values among devices in various ways. For example, devices connected by a timer synchronization bus can synchronize by employing one of the devices as a controller that samples its own time stamp counter value, receives samples from one or more other devices, and synchronizes the timers of the devices. For example, the controller device can generate offsets for each of the time stamp counter values based on two's complements of the samples or based on differences between the samples.

A two's complement can be a number derived from an original number that, when summed with the original number produces 2^{N}, where N is the number of digits in the original number. With binary numbers, for example, an example procedure for generating a two's complement can be taking the one's complement (e.g., inverting, flipping the bits, etc.) of the original binary number and adding 1 to the least significant bit. To demonstrate, a two's complement of an original number 10010 can be 01101+1=01110.

In an example, the controller device can generate offsets for each of the time stamp counter values based on two's complements of the samples, apply its own offset, and communicate the other offsets to the respective other devices, which can apply the received offsets. In this example, global time can be synchronized in a way that causes all of the time stamp counters to go backward in time to a common point in time. For example, a first device (e.g., socket and/or die) can record a first sample of a first time stamp counter value (e.g., of the first device) based on the capture of the activation edge of the synchronization event and offset the first time stamp counter value based on a two's complement of the first sample. Additionally, a first device (e.g., socket and/or die) can receive a second sample of a second time stamp counter value (e.g., of a second device, from a second device, etc.) and offset the second time stamp counter value based on a two's complement of the second sample. Also, a first device can record the aforementioned first sample, receive the aforementioned second sample, offset the first time stamp counter value based on a two's complement of the first sample, and offset the second time stamp counter value based on a two's complement of the second sample. Further, a first device can record the aforementioned first sample, receive the aforementioned second sample, receive a third sample from a third device, and offset a third time stamp counter value based on a two's complement of the third sample.

In another example, the controller device can determine which of the samples has a greatest value, generate offsets based on differences between this greatest value and the samples, apply its own offset, and communicate the other offsets to the respective other devices, which can apply the received offsets. In this example, global time can be synchronized in a way that causes all of the time stamp counters (e.g., except for the one that sent the sample having the greatest value) to go forward in time to a common point in time, thus catching up to the device that sent the sample having the greatest value (e.g., which can receive and apply a zero value offset). For example, a first device can record the aforementioned first sample, receive the aforementioned second sample, and offset the second time stamp counter value based on a difference between the second sample and the first sample. Additionally, a first device can record the aforementioned first sample, receive the aforementioned second sample, and offset the first time stamp counter value based on a difference between the first sample and the second sample. Also, a first device can record the aforementioned first sample, receive the aforementioned second sample, receive a third sample from a third device, and offset a third time stamp counter value based on a difference between the first sample and the third sample. Further, a first device can record the aforementioned first sample, receive the aforementioned second sample, receive the aforementioned third sample from a third device, and offset a third time stamp countervalue based on a difference between the second sample and the third sample.

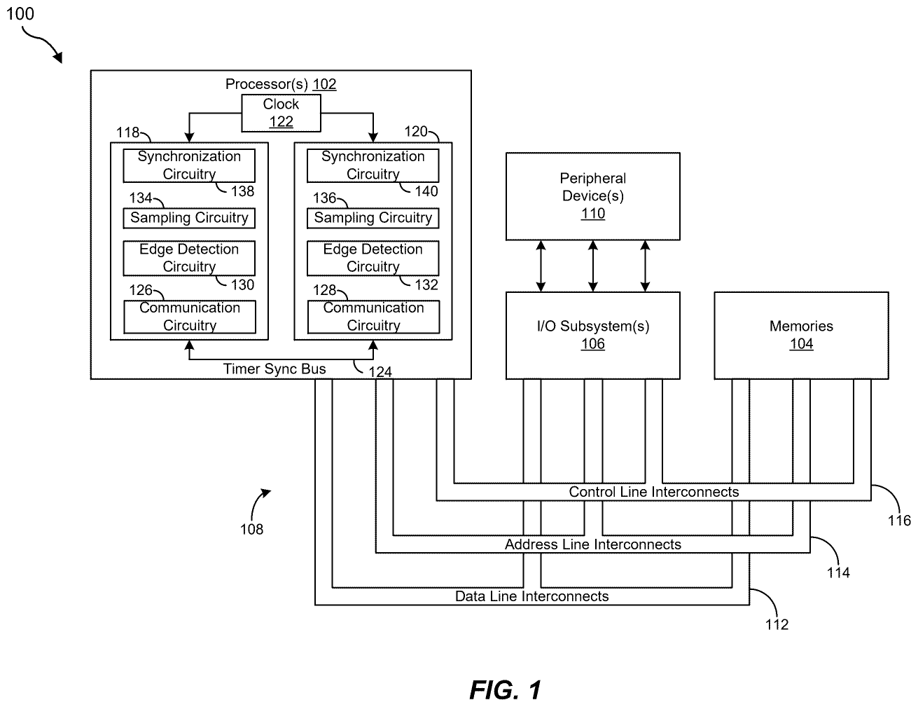

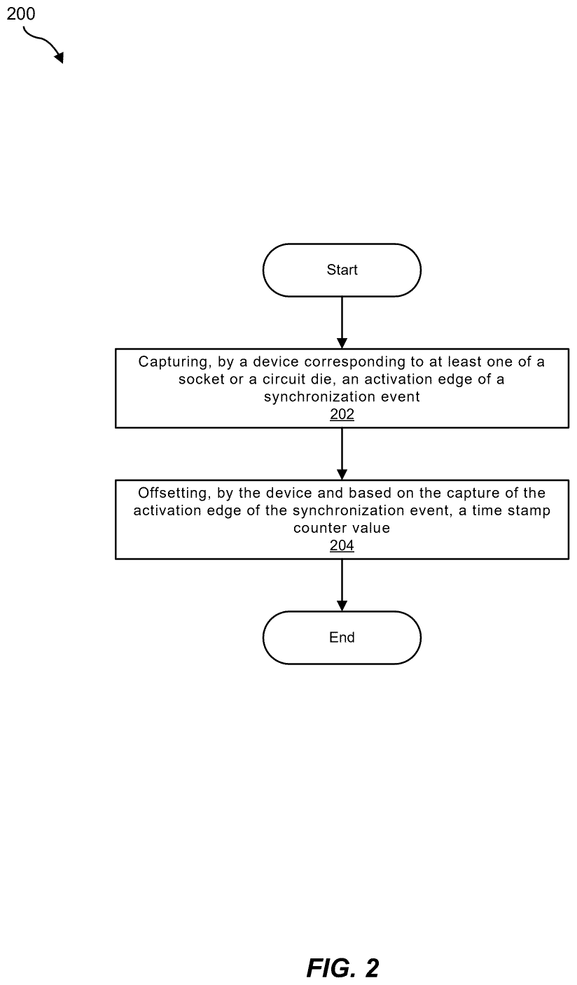

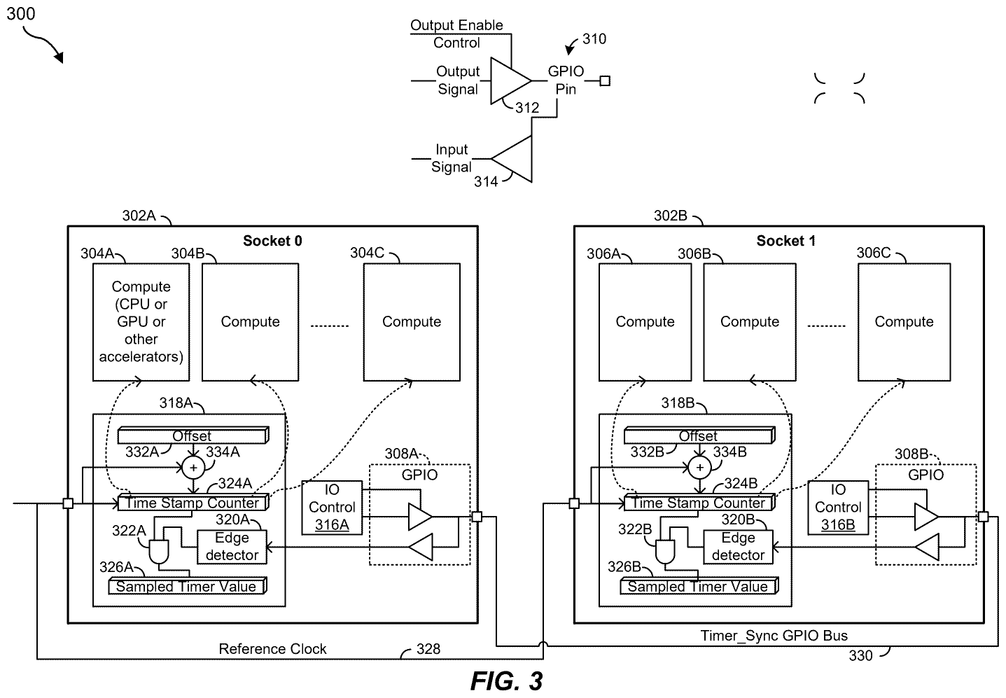

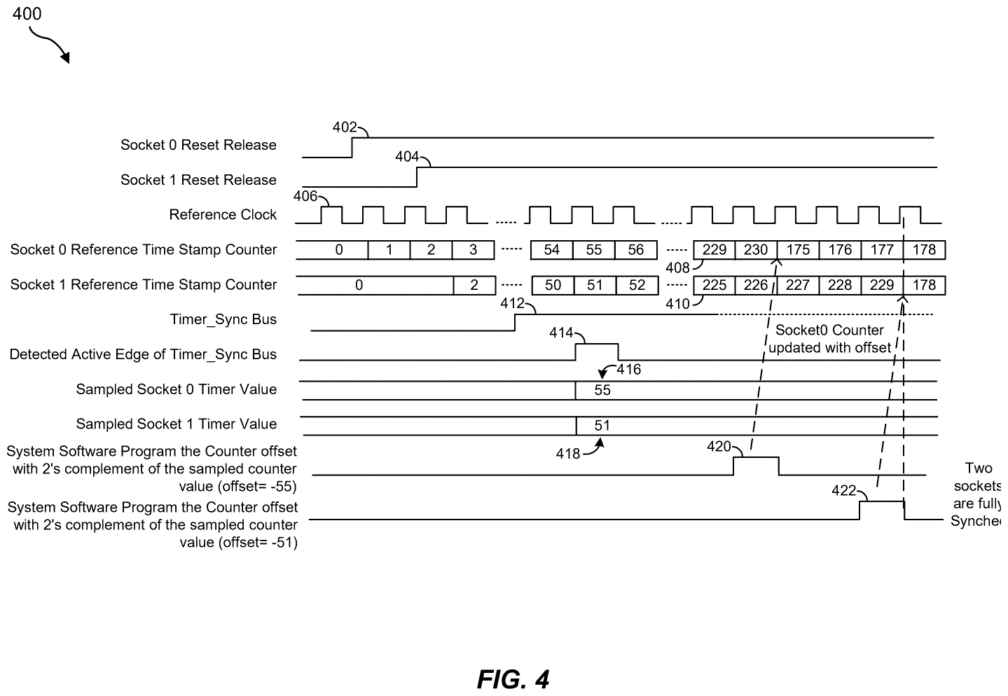

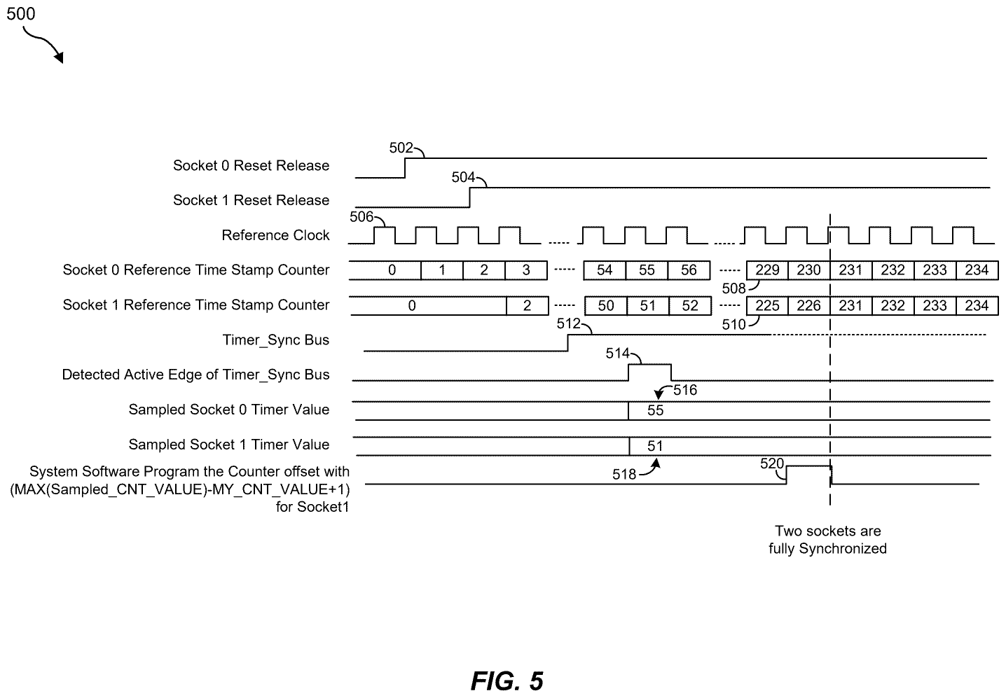

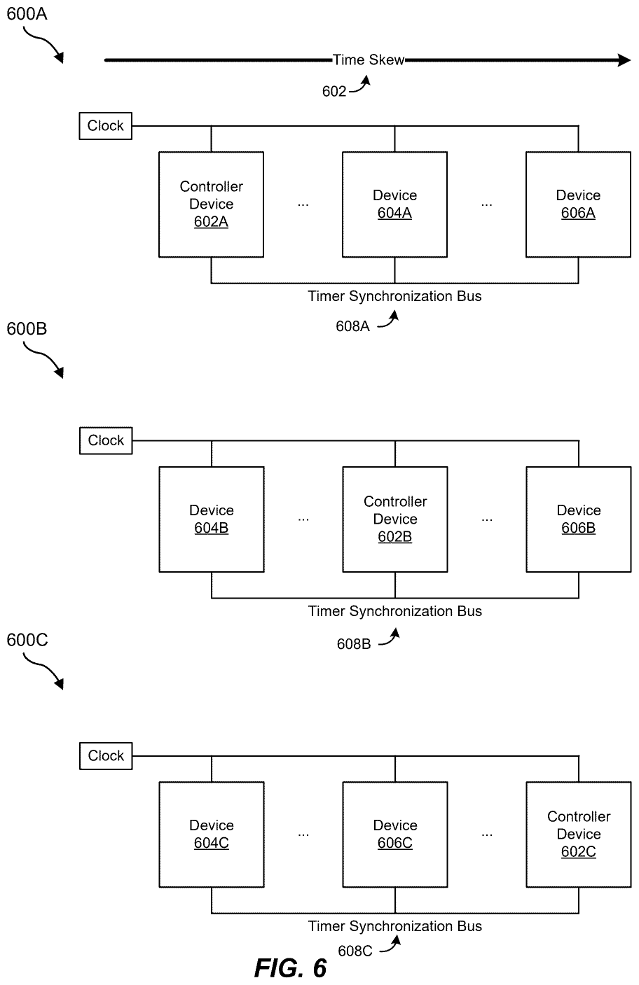

The following will provide, with reference to FIG. 1, detailed descriptions of example systems for timer synchronization. Detailed descriptions of corresponding methods will also be provided in connection with FIG. 2. In addition, detailed descriptions of example systems implementing timer synchronization will be provided in connection with FIGS. 3 and 6. Also, detailed descriptions of example timer synchronization signaling will be provided in connection with FIGS. 4 and 5.

In one example, a device can include edge detection circuitry configured to capture an activation edge of a synchronization event and synchronization circuitry configured to offset a time stamp counter value based on the capture of the activation edge of the synchronization event.

Another example can be the previously described example device, wherein the synchronization circuitry is configured to offset the time stamp counter value based on one or more samples of one or more time stamp counter values.

Another example can be any of the previously described example devices, wherein the synchronization circuitry is configured to offset the time stamp counter value based on a two's complement of a sample of the one or more time stamp counter values.

Another example can be any of the previously described example devices, wherein the synchronization circuitry is configured to offset the time stamp counter value based on a difference between two or more samples of two or more time stamp counter values.

Another example can be any of the previously described example devices, wherein the synchronization circuitry is configured to offset the time stamp counter value based on satisfaction of a threshold condition.

Another example can be any of the previously described example devices, wherein the threshold condition is based on a first sample of the time stamp counter value being less than a second sample of the two or more samples.

Another example can be any of the previously described example devices, further including sampling circuitry configured to record a sample of the time stamp counter value based on the capture of the activation edge of the synchronization event.

Another example can be any of the previously described example devices, further including communication circuitry configured to trigger the synchronization event over a timer synchronization bus.

Another example can be any of the previously described example devices, wherein the communication circuitry corresponds to bi-directional communication circuitry having a single input output pin with configurable directions and output values.

Another example can be any of the previously described example devices, wherein the device is configured to conduct a time stamp synchronization procedure at least in part by setting an output of the communication circuitry to an active state.

Another example can be any of the previously described example devices, wherein the device corresponds to at least one of a socket or a circuit die.

In one example, a system can include a first device configured to perform a first capture of an activation edge of a synchronization event and record a first sample of a first time stamp counter value based on the first capture, a second device configured to perform a second capture of the activation edge of the synchronization event and record a second sample of a second time stamp counter value based on the second capture, wherein the first device and the second device each correspond to at least one of a socket or a circuit die, and a timer synchronization bus, wherein the second device is configured to sense the synchronization event on the timer synchronization bus and communicate the second sample to the first device and the first device is configured to trigger the synchronization event on the timer synchronization bus and offset of at least one of the first time stamp counter value or the second time stamp counter value based on at least one of the first sample or the second sample.

Another example can be the previously described example system, wherein the first device is configured to offset the first time stamp counter value based on at least one of a two's complement of the first sample or a difference between the second sample and the first sample.

Another example can be any of the previously described example systems, wherein the first device is configured to offset the second time stamp counter value based on at least one of a two's complement of the second sample or a difference between the first sample and the second sample.

Another example can be any of the previously described example systems, further including a third device corresponding to at least one of a socket or a circuit die and configured to perform a third capture of the activation edge of the synchronization event on the timer synchronization bus and record a third sample of a third time stamp counter value based on the third capture, wherein the third device is configured to communicate the third sample to the first device and the first device is configured to offset the third time stamp counter value based on at least one of a two's complement of the third sample, a difference between the first sample and the third sample, or a difference between the second sample and the third sample.

Another example can be any of the previously described example systems, wherein the first device is configured to generate a first offset of the first time stamp counter value based on a first two's complement of the first sample, apply the first offset to the first time stamp counter value, generate a second offset of the second time stamp counter value based on a second two's complement of the second sample, and communicate the second offset to the second device over the timer synchronization bus.

Another example can be any of the previously described example systems, wherein the first device and the second device each includes a single input output pin with configurable directions and output values and that is connected to the timer synchronization bus.

Another example can be any of the previously described example systems, wherein the first device is configured to conduct a time stamp synchronization procedure at least in part by generating the activation edge on the timer synchronization bus.

In one example, a method can include capturing, by a device corresponding to at least one of a socket or a circuit die, an activation edge of a synchronization event and offsetting, by the device and based on the capture of the activation edge of the synchronization event, a time stamp counter value.

Another example can be the previously described example method wherein the device is configured to offset the time stamp counter value based on one or more samples of one or more time stamp counter values.

FIG. 1 illustrates an example system 100 with timer synchronization. For example, system 100 can include one or more processors 102, one or more memories 104, and one or more input/output (I/O) subsystems 106 connected by a system bus 108. Processors 102 can include central processing units (CPUs) and/or co-processors, such as graphics processing units (GPUs), accelerator processing units (APUs), arithmetic logic units (ALUs), etc. Memories 104 can correspond to electronic holding places for the instructions and/or data that a computer needs to reach quickly, such as cache memory, main memory, and/or secondary memory. 1/O subsystems 106 can correspond to devices that transfer data to and/or from a computer and control communication between processors 102 and peripheral devices 110. Peripheral devices 110 can correspond to devices that connect to a core computing unit, such as monitors, mice, keyboards, printers, external memory, etc. In turn, I/O subsystems 106 can include controllers for each of the peripheral devices 110. One or more processors 102, one or more memories 104, and one or more input/output (I/O) subsystems 106 can be implemented as one or more semiconductor device packages connected to one or more printed circuit boards.

As shown in FIG. 1, a system bus 108 can be a communication system that transfers data between components inside a computer, or between computers. System bus 108 can include various interconnects, such as data line interconnects 112, address line interconnects 114, and control line interconnects 116. Data line interconnects 112, in the context of technology and computing, can refer to a communication path that facilitates the transmission of data between devices or systems. Address line interconnects 114 can refer to a physical connection between a CPU/chipset and memory and specify which address to access in the memory. Control line interconnects 116 can receive signals that manage varied chip operations (e.g., scan and write). One or more processors 102 can implement timer synchronization as described herein.

As shown in FIG. 1, processors 102 can include devices 118 and 120 that can correspond to different sockets of a PCB, different circuit die in a same socket, or different circuit die in different sockets. Devices 118 and 120 can receive clock signals from a system clock 122. In some implementations, devices 118 and 120 can exit reset after initial power up and begin counting and incrementing their respective system time stamp counters on every clock cycle of system clock 122. All of the time stamp counters in different sockets or circuit dies can be sourced from the same system clock 122 to avoid frequency deltas and long term frequency drifting.

As shown in FIG. 1, devices 118 and 120 can also be connected to one another by a timer synchronization bus 124. In some implementations, timer synchronization bus 124 can be a general purpose 10 (GPIO) bus provided in a socket substrate and/or the PCB. Additionally, each circuit die, of which multiple circuit die can be present in an SoC, can include a single GPIO pin shorted to the timer synchronization bus. Communication circuitry 126 and 128 can each include such a pin connected to an input receiver and an output driver with output enable (OE) control. In an example, when the OE control is set to zero (e.g., disabled) then the pin can function as input and when the OE control is set to one (i.e., enabled) then the pin can function as output.

As shown in FIG. 1, device 118 can be designated as a controller device that can coordinate a synchronization procedure after the devices are powered up but before they become functional. For example, device 118 can operate communication circuitry 126 by setting it to output mode while communication circuitry 128 of device 120 can remain in input mode. Additionally, device 118 can assert a synchronization event by placing the output of the communication circuitry 126 into an active state (e.g., logic level one), thus generating a timer synchronization signal on the timer synchronization bus. This timer synchronization signal can have an activation edge.

As shown in FIG. 1, edge detection circuitry 130 of device 118 and edge detection circuitry 132 of device 120 can capture an activation edge of the synchronization event. Sampling circuitry 134 and 136 of devices 118 and 120 can respond to the capture of the activation edge by sampling (e.g., capturing) their respective local time counter values and storing these samples in one or more readable registers, which can be implemented locally among processors 102 and/or among memories 104. Device 118 can then read and fetch all of the stored samples from the one or more registers.

As shown in FIG. 1, synchronization circuitry 138 of device 118 can generate offsets for the samples that can respectively offset the local time counter values and cause them to become synchronized. In one example, synchronization circuitry can generate the offsets based on two's complements of the samples. In another example, synchronization circuitry can generate the offsets based on differences between a sample having a greatest value and the samples. Device 118 can then program the generated offsets back to the respective devices. For example, device 118 can store the offsets in one or more readable registers designated for the different devices.

As shown in FIG. 1, devices 118 and 120 can read and fetch their respective offsets. Additionally, synchronization circuitry 138 and 140 of devices 118 and 120 can apply their respective offsets to their respective local time counter values, causing them to become synchronized. This synchronization can compensate time skew among the time stamp counters of the devices 118 and 120, such as time skew caused by asynchronous reset release of different time stamp counters among different devices.

FIG. 2 illustrates an example method 200 for timer synchronization. The steps of FIG. 1 can be performed by hardware, software, or combinations of hardware and software. For example, hardware can correspond to analog circuitry, digital circuitry, communication media, or combinations thereof. In some implementations, hardware can correspond to digital and/or analog circuitry arranged to carry out one or more portions of the method 200. In some implementations, hardware can correspond to system 100, device 118 of FIG. 1, and/or portions thereof. Example types of hardware can include chiplets, monolithic die, microprocessors, microcontrollers, CPUs, GPUs, APUs, Field-Programmable Gate Arrays (FPGAs) that implement softcore processors, Application-Specific Integrated Circuits (ASICs), portions of one or more of the same, variations or combinations of one or more of the same, or any other suitable processor. Additionally, software can correspond to software applications or programs that, when executed by the hardware, can cause the hardware to perform one or more tasks that carry out one or more portions of the method 200.

At step 202, method 200 can include capturing an activation edge. For example, step 202 can include capturing, by a device corresponding to at least one of a socket or a circuit die, an activation edge of a synchronization event.

Method 200 can perform step 202 in various ways. For example, edge detection circuitry 130 of device 118 of FIG. 1 can, at step 202, sense the synchronization event on the timer synchronization bus 124 of FIG. 1. In another example, edge detection circuitry 130 of device 118 of FIG. 1 can, at step 202, detect assertion of a logical one on the timer synchronization bus 124 of FIG. 1. In another example, edge detection circuitry 130 of device 118 of FIG. 1 can, at step 202, detect a rising edge of a timer synchronization signal generated on the timer synchronization bus.

At step 204, method 200 can include offsetting a value. For example, step 204 can include offsetting, by the device and based on the capture of the activation edge of the synchronization event, a time stamp counter value.

Method 200 can perform step 204 in a variety of ways. For example, synchronization circuitry 138 of device 118 of FIG. 1 can, at step 204, offset the time stamp counter value based on one or more samples of one or more time stamp counter values. In another example, synchronization circuitry 138 of device 118 of FIG. 1 can, at step 204, offset the time stamp counter value based on a two's complement of a sample of the time stamp counter values. In another example, synchronization circuitry 138 of device 118 of FIG. 1 can, at step 204, offset the time stamp counter value based on a difference between two or more samples of two or more time stamp counter values. In another example, synchronization circuitry 138 of device 118 of FIG. 1 can, at step 204, offset the time stamp counter value based on satisfaction of a threshold condition. In another example, synchronization circuitry 138 of device 118 of FIG. 1 can, at step 204, offset the time stamp counter value based on satisfaction of a threshold condition that is based on a first sample of the time stamp counter value being less than a second sample of the two or more samples.

Steps 202 and 204 of method 200 can include one or more additional procedures. For example, sampling circuitry 134 of device 118 of FIG. 1 can, at steps 202 and/or 204, record a sample of the time stamp counter value based on (e.g., in response to) the capture of the activation edge of the synchronization event at step 202. In another example, communication circuitry 126 of device 118 of FIG. 1 can, at steps 202 and/or 204, trigger the synchronization event over a timer synchronization bus. In some of these examples, the communication circuitry 126 of device 118 of FIG. 1 can correspond to bi-directional communication circuitry having a single input output pin with configurable directions and output values. In another example, device 118 of FIG. 1 can, at steps 202 and/or 204, conduct a time stamp synchronization procedure at least in part by setting an output of the communication circuitry to an active state (e.g., a logical one).

FIG. 3 illustrates an example system 300 implementing timer synchronization. In system 100, the devices 118 and 120 of FIG. 1 can correspond to sockets 302A and 302B that contain multiple processors 304A, 304B, 304C, 306A, 306B, and 306C that can correspond to CPUs, GPUs, APUs, etc. Processors 304A, 304B, 304C, 306A, 306B, and 306C can correspond to SoCs that include one or more circuit die, such as monolithic die or multiple die (e.g., three-dimensionally (3D) stacked die).

As shown in FIG. 3, each socket 302A and 302B can include bidirectional communication circuitry 308A and 308B that can correspond to an implementation of communication circuitry 126 and 128 of FIG. 1. For example, communication circuitry 308A and 308B can include a single GPIO pin 310, an input receiver 312, an output driver 314, and OE control 316A and 316B connected as shown in FIG. 3. Alternatively or additionally, each die of processors 304A, 304B, 304C, 306A, 306B, and 306C can include such bidirectional communication circuitry.

As shown in FIG. 3, each socket 302A and 302B can also include circuitry 318A and 318B that can include circuit elements affecting all or part of edge detection circuitry 130 and 132, sampling circuitry 134 and 136, and/or synchronization circuitry 138 and 140 of FIG. 1. For example, circuitry 318A and 318B can include edge detectors 320A and 320B that can receive input signals from output drivers of communication circuitry 308A and 308B. In some implementations, edge detectors 320A and 320B can correspond to flip flops that function as edge-triggered storage elements whose outputs change in response to an activation edge received on the input signals. Also, circuitry 318A and 318B can include gates 322A and 322B connected to receive inputs from edge detectors 320A and 320B and from time stamp counters 324A and 324B that can be stored, for example, in local registers. When the outputs of edge detectors 320A and 320B change, gates 322A and 322B can sample the values of time stamp counters 324A and 324B and store the resulting samples in local registers 326A and 326B.

As shown in FIG. 3, socket 302A and/or one or more circuit dies of processors 304A, 304B, and/or 304C can be designated as a controller device that can coordinate a synchronization procedure after the sockets 302A and 302B and circuit dies of processors 304A, 304B, 304C, 306A, 306B, and 306C are powered up but before they become functional. For example, bidirectional communication circuitry 308A and 308B can be in input mode by default at power up with weakly pull-up as a safe default value. When the system time counter exits reset, it can start to count and increment on every clock cycle of a reference clock signal 328. After sockets 302A and 302B are powered up, and before processors 304A, 304B, 304C, 306A, 306B, and 306C become functional, one or more of processors 304A-304C can perform portions of the synchronization procedure by causing OE control 316A to set bidirectional communication circuitry 308A to output mode and placing the output of bidirectional communication circuitry 308A into an active state (e.g., logic level one). In this way, a timer synchronization signal can be generated on a timer synchronization bus 330. This timer synchronization signal can have an activation edge that can trigger edge detectors 320A and 320B, causing gates 322A and 322B to record sample values of time stamp counters 324A and 324B. One or more of processors 304A-304C can then read and fetch these samples and generate offsets 332A and 332B that one or more of processors 304A-304C can program into local registers of sockets 302A and 302B. Adders 334A and 334B can then apply these offsets to the time stamp counters 324A and 324B, synchronizing the time stamp counters 324A and 324B.

FIG. 4 illustrates example timer synchronization signaling 400 with offsets that are based on two's complements of sampled time stamp counter values as previously described with reference to FIGS. 1-3. For example, reset release signals 402 and 404 for two different sockets may be asynchronous, causing the sockets to begin counting cycles of a reference clock signal 406 at different points in time. As a result, reference time stamp counters 408 and 410 may be incremented out of sync with one another. When a timer synchronization signal 412 is generated on the timer synchronization bus, an activation edge 414 can be detected, resulting in samples 416 and 418 of time stamp counter values of each socket. Offsets for each sample 416 and 418 can be determined as the two's complements of the sampled values. Application of these offsets at 420 and 422 to the respective time stamp counters 408 and 410 can result in synchronization of the time stamp counter 408 and 410, affectively compensating time skew caused by asynchronicity of the reset release signals 402 and 404.

FIG. 5 illustrates example timer synchronization signaling 500 with offsets that are based on differences between sampled time stamp counter values as previously described with reference to FIGS. 1-3. For example, reset release signals 502 and 504 for two different sockets may be asynchronous, causing the sockets to begin counting cycles of a reference clock signal 506 at different points in time. As a result, reference time stamp counters 508 and 510 may be incremented out of sync with one another. When a timer synchronization signal 512 is generated on the timer synchronization bus, an activation edge 514 can be detected, resulting in samples 516 and 518 of time stamp counter values of each socket. An offset can be determined based on a difference between a greatest sample value and another sampled value. For example, an offset O can be determined according to:

$$O = Max S - Other S + 1 ,$$

where Max S is the sample having the greatest value and Other S is the other sample. This offset can be programmed to the socket corresponding to the other sampled value. Application of this offset at 520 to the respective time stamp counters 510 can result in synchronization of the time stamp counter 508 and 510, affectively compensating time skew caused by asynchronicity of the reset release signals 502 and 504.

FIG. 6 illustrates example systems 600A, 600B, and 600C implementing timer synchronization with offsets that are based on differences between sampled time stamp counter values as previously described with reference to FIGS. 1-3 and 5. For example, assuming that time skew 602 increases from left to right, a controller device 604A, 604B, and 604C can synchronize the devices in such a way that all other devices catch up to devices that are furthest to the right, and thus have time stamp counters with greatest values. As a result, the system time can avoid going back in time in order to synchronize the devices.

As shown in FIG. 6, system 600A can include three devices 602A, 604A, and 606A. Controller device 602A can be a leftmost device having a time stamp counter of least value and devices 604A and 606A can have time stamp counters of increasing value. Being furthest to the right, device 606A can have the time stamp counter with the greatest value. Controller device 602A can generate the timer synchronization signal on the timer synchronization bus 608A and obtain samples from devices 604A and 606A. Observing that the sample from device 606A has the greatest value, controller device 602A can generate an offset for itself based on a difference between the sample of device 606A and the sample of controller device 602A. Also, controller device 602A can generate an offset for device 604A based on a difference between the sample of device 606A and the sample of device 604A. Devices 602A and 604A can apply their respective offsets to synchronize their respective time stamp counters with a time stamp counter of device 606A.

As shown in FIG. 6, system 600B can include three devices 602B, 604B, and 606B. Controller device 602B can be a middle device having a time stamp counter of intermediate value and devices 604B and 606B can have time stamp counters of lesser and greater value, respectively. Being furthest to the right, device 606B can have the time stamp counter with the greatest value. Controller device 602B can generate the timer synchronization signal on the timer synchronization bus 608B and obtain samples from devices 604B and 606B. Observing that the sample from device 606B has the greatest value, controller device 602B can generate an offset for itself based on a difference between the sample of device 606B and the sample of controller device 602B. Also, controller device 602B can generate an offset for device 604B based on a difference between the sample of device 606B and the sample of device 604B. Devices 602B and 604B can apply their respective offsets to synchronize their respective time stamp counters with a time stamp counter of device 606B.

As shown in FIG. 6, system 600C can include three devices 602C, 604C, and 606C. Controller device 602C can be a rightmost device having a time stamp counter of greatest value and devices 604C and 606C can have time stamp counters of lesser values. Controller device 602C can generate the timer synchronization signal on the timer synchronization bus 608C and obtain samples from devices 604C and 606C. Observing that its own sample has the greatest value, controller device 602C can generate an offset for device 604C based on a difference between the sample of controller device 602C and the sample of device 604C. Also, controller device 602C can generate an offset for device 606C based on a difference between the sample of controller device 602C and the sample of device 606C. Devices 604C and 606C can apply their respective offsets to synchronize their respective time stamp counters with a time stamp counter of controller device 602C.

As set forth above, the disclosed systems and methods can synchronize devices (e.g., circuit dies and/or sockets) by capturing an activation edge of a synchronization event and offsetting a time stamp counter value. Benefits obtained by the disclosed systems and methods can include reduced skew among different time stamp counters of the synchronized devices. For example, the disclosed systems and methods can compensate time skew caused by asynchronous reset release of different time stamp counters among different devices.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
edge detection circuitry configured to capture an activation edge of a synchronization event; and
synchronization circuitry configured to offset a time stamp counter value based on the capture of the activation edge of the synchronization event.

2. The device of claim 1, wherein the synchronization circuitry is configured to offset the time stamp counter value based on one or more samples of one or more time stamp counter values.

3. The device of claim 2, wherein the synchronization circuitry is configured to offset the time stamp counter value based on a two's complement of a sample of the one or more time stamp counter values.

4. The device of claim 2, wherein the synchronization circuitry is configured to offset the time stamp counter value based on a difference between two or more samples of two or more time stamp counter values.

5. The device of claim 4, wherein the synchronization circuitry is configured to offset the time stamp counter value based on satisfaction of a threshold condition.

6. The device of claim 5, wherein the threshold condition is based on a first sample of the time stamp counter value being less than a second sample of the two or more samples.

7. The device of claim 1, further comprising:
sampling circuitry configured to record a sample of the time stamp counter value based on the capture of the activation edge of the synchronization event.

8. The device of claim 1, further comprising:
communication circuitry configured to trigger the synchronization event over a timer synchronization bus.

9. The device of claim 8, wherein the communication circuitry corresponds to bi-directional communication circuitry having a single input output pin with configurable directions and output values.

10. The device of claim 8, wherein the device is configured to conduct a time stamp synchronization procedure at least in part by setting an output of the communication circuitry to an active state.

11. The device of claim 1, wherein the device corresponds to at least one of a socket or a circuit die.

12. A system, comprising:
a first device configured to perform a first capture of an activation edge of a synchronization event and record a first sample of a first time stamp counter value based on the first capture;
a second device configured to perform a second capture of the activation edge of the synchronization event and record a second sample of a second time stamp counter value based on the second capture, wherein the first device and the second device each correspond to at least one of a socket or a circuit die; and
a timer synchronization bus, wherein the second device is configured to sense the synchronization event on the timer synchronization bus and communicate the second sample to the first device and the first device is configured to trigger the synchronization event on the timer synchronization bus and offset of at least one of the first time stamp counter value or the second time stamp counter value based on at least one of the first sample or the second sample.

13. The system of claim 12, wherein the first device is configured to offset the first time stamp counter value based on at least one of:
a two's complement of the first sample; or
a difference between the second sample and the first sample.

14. The system of claim 12, wherein the first device is configured to offset the second time stamp counter value based on at least one of:
a two's complement of the second sample; or
a difference between the first sample and the second sample.

15. The system of claim 12, further comprising:
a third device corresponding to at least one of a socket or a circuit die and configured to perform a third capture of the activation edge of the synchronization event on the timer synchronization bus and record a third sample of a third time stamp counter value based on the third capture,
wherein the third device is configured to communicate the third sample to the first device and the first device is configured to offset the third time stamp counter value based on at least one of:
a two's complement of the third sample;
a difference between the first sample and the third sample; or
a difference between the second sample and the third sample.

16. The system of claim 12, wherein the first device is configured to:
generate a first offset of the first time stamp counter value based on a first two's complement of the first sample;
apply the first offset to the first time stamp counter value;
generate a second offset of the second time stamp counter value based on a second two's complement of the second sample; and
communicate the second offset to the second device over the timer synchronization bus.

17. The system of claim 12, wherein the first device and the second device each includes a single input output pin with configurable directions and output values and that is connected to the timer synchronization bus.

18. The system of claim 12, wherein the first device is configured to conduct a time stamp synchronization procedure at least in part by generating the activation edge on the timer synchronization bus.

19. A method, comprising:
capturing, by a device corresponding to at least one of a socket or a circuit die, an activation edge of a synchronization event; and
offsetting, by the device and based on the capture of the activation edge of the synchronization event, a time stamp counter value.

20. The method of claim 19, wherein the device is configured to offset the time stamp counter value based on one or more samples of one or more time stamp counter values.
